(19) United States
(12) Patent Application Publication
(10) Pub. No.: US 2023/0055773 A1
(43) Pub. Date: Feb. 23, 2023

(54) OBJECT TRACKING METHOD, DEVICE, BACKEND AND MEDIUM

(71) Applicant: SHANGHAI JIAO TONG UNIVERSITY, Shanghai (CN)

(72) Inventors: Dongyao CHEN, Shanghai (CN); Xinbing WANG, Shanghai (CN); Chenghu ZHOU, Shanghai (CN)

(73) Assignee: SHANGHAI JIAO TONG UNIVERSITY, Shanghai (CN)

(21) Appl. No.: 17/892,159

(22) Filed: Aug. 22, 2022

(30) Foreign Application Priority Data
Aug. 23, 2021 (CN) 2021109681179
Sep. 3, 2021 (CN) 202111032010X

(51) Int. Cl. G06F 3/01

(52) U.S. Cl. CPC G06F 3/011; G06F 3/017

(57) ABSTRACT

An object tracking method, device, backend, and medium. The object tracking method includes: obtaining raw sensor data sent by a sensor array, the sensor array including a plurality of magnetic field sensors, the raw sensor data including magnetic field strengths at locations of the magnetic field sensors; determining the presence of a target magnet based on the raw sensor data, where the target magnet is a permanent magnet provided on a target object; when the target magnet is present, tracking the target magnet based on the raw sensor data. The method enables permanent-magnet-based object tracking.

### CROSS REFERENCE TO RELATED APPLICATION

This application claims the benefits of priority to Chinese Patent Application No. CN 202111032010.X filed with CNIPA on Sep. 3, 2019, and Chinese Patent Application No. CN 202110968117.9 filed with CNIPA on Aug. 23, 2020, the contents of which are incorporated herein by reference in its entirety.

### BACKGROUND

### Field of Disclosure

The present disclosure relates to a tracking method, and in particular, to an object tracking method, device, backend, and medium.

### Description of Related Arts

As one of the most expressive parts of the human body, the hands offer a natural way to interact with machines and the surrounding environment. Precise hand tracking technology helps boost user experience by improving the immersion of the interaction, which is critical to VR/AR environments. Furthermore, hand gestures are usually relevant to mental stress (e.g., subconscious hair pulling, lip picking, fingernail chewing) and physical well-being (hand-washing and face-touching).

Many prior studies have gravitated toward using cameras and/or Inertial Measurement Units (IMUs) as sensors to track users' hands. Currently, the camera-based approaches have enabled high-precision hand segmentation and tracking. However, the line-of-sight (LoS) requirement, high energy/computation costs, and privacy concerns hamper the adoption of these methods for mobile applications. IMUs offer a solution to these issues. Specifically, IMUs can be placed in any strategic location on the human body to allow direct query of the state of the deployed position. IMUs are not reliant on LoS and do not pose a privacy issue in the same manner as cameras. However, IMUs' fundamental limitation is its drifting problem, where the estimated position accumulates tracking errors over time.

### SUMMARY

The present disclosure provides an object tracking method, device, backend, and medium.

A first aspect of the present disclosure provides a permanent-magnet-based object tracking method applied to a backend of a tracking device, the method including: obtaining raw sensor data sent by a sensor array, the sensor array including a plurality of magnetic field sensors, the raw sensor data including magnetic field strengths at the locations of the sensors; determining the presence of a target magnet based on the raw sensor data, where the target magnet is a permanent magnet provided on a target object; when the target magnet is present, tracking the target magnet based on the raw sensor data.

In an embodiment of the first aspect, the determining of the presence of a target magnet based on the raw sensor data includes: classifying, using a trained classifier model, the raw sensor data, to determine the presence of the target magnet.

In an embodiment of the first aspect, a method for implementing, tracking of the target magnet includes: for each magnetic field sensor in the sensor array, establishing an equation between magnetic field strength collected by the magnetic field sensor and pose parameters of the target magnet; acquiring the pose parameters of the target magnet based on the equation, thereby enabling tracking of the target magnet.

In an embodiment of the first aspect, the pose parameters include a magnetic moment vector of the target magnet and a position vector pointing from the target magnet to the sensor array. The equation can be expressed as:

$$\vec{{B}_{i}} = \vec{G} + {\sum }_{j = 1}^{n} \frac{{μ}_{0}}{4 π} ⨯ ( \frac{3 ⨯ ( {\vec{m}}_{j} ⨯ {\vec{r}}_{ij} )}{{\vert {\vec{r}}_{ij} \vert}^{5}} - \frac{{\vec{m}}_{j}}{{\vert {\vec{r}}_{ij} \vert}^{3}} ) ,$$

where [symbol] is the magnetic field strength collected by the [symbol] -th magnetic field sensor in the sensor array, [symbol] is the number of the target magnets, [symbol] is the environmental magnetic field strength, [symbol] is the vacuum permeability, [symbol] is the magnetic moment vector of the [symbol] -th target magnet, and [symbol] is the position vector pointing from the [symbol] -th target magnet to the [symbol] -th magnetic field sensor.

In an embodiment of the first aspect, a method for designing the sensor array includes: determining the layer number of the layout of the sensor array; determining the inter-layer distance of the sensor array; and determining the position of each magnetic field sensor in the sensor array.

In an embodiment of the first aspect, the sensor array is calibrated, so that each of the magnetic field sensors in the sensor array collects uniform magnetic field strength when rotated to different directions.

In an embodiment of the first aspect, the method further includes: using a tracking tool to obtain the position and orientation of the target magnet in the tracking tool coordinate system; translating the position and orientation of the target magnet in the tracking tool coordinate system to the position and orientation in the backend coordinate system; and evaluating the tracking performance of the backend based on the position and orientation of the target magnet in the backend coordinate system.

A second aspect of the present disclosure provides a backend of an object tracking device, the backend including: a sensor array for obtaining magnetic field data at the location of the sensor array as raw sensor data, the sensor array including a plurality of magnetic field sensors; a processor, communicatively connected to the sensor array, for determining the presence of a target magnet based on the raw sensor data, and when the target magnet is present, tracking the target magnet based on the raw sensor data; the target magnet is a permanent magnet provided on a target object.

A third aspect of the present disclosure provides a permanent-magnet-based object tracking device, which includes: at least one target magnet provided on the target object, the target magnet being a permanent magnet; a backend, including a sensor array and a processor, where the sensor array is used to obtain magnetic field data at the location of the sensor array as raw sensor data, and the processor is communicatively connected to the sensor array, for determining the presence of the target magnet based on the raw sensor data, and tracking, when the target magnet is present, the target magnet based on the raw sensor data.

A fourth aspect of the present disclosure provides a non-transitory computer-readable storage medium, which stores a computer program, where the computer program implements the permanent-magnet-based object tracking method of the first aspect of the present disclosure when executed by a processor.

As described above, the permanent-magnet-based object tracking method in one or more embodiments of the present disclosure has the following beneficial effects:

When the target object is a hand of a user, the object tracking method enables accurate hand tracking based on a magnetic field, which is line-of-sight independent and does not infringe on the user's privacy. Further, since permanent magnets require no maintenance, they can be worn on the hand all the time, with only the sensor plate needing to be charged, just like a smartwatch. In addition, as the permanent-magnet-based object tracking method does not depend on the IMU unit for implementation, there are no drifting problems.

### BRIEF DESCRIPTION OF THE DRAWINGS

FIG. 1 shows a flowchart of a permanent-magnet-based object tracking method according to an embodiment of the present disclosure.

FIG. 2 shows a flowchart of the training of a classifier model in a permanent-magnet-based object tracking method according to an embodiment of the present disclosure.

FIG. 3 shows a flowchart of operation S13 of a permanent-magnet-based object tracking method according to an embodiment of the present disclosure.

FIG. 4 shows a flowchart of key steps of a permanent-magnet-based object tracking method in an embodiment of the present disclosure.

FIG. 5 shows a flowchart of key steps of a permanent-magnet-based object tracking method according to an embodiment of the present disclosure.

### DETAILED DESCRIPTION

The embodiments of the present disclosure will be described below. Those skilled in the art can easily understand other advantages and effects of the present disclosure according to contents disclosed by the specification. The present disclosure may also be implemented or applied through other different specific implementation modes. Various modifications or changes may be made to all details in the specification based on different points of view and applications without departing from the spirit of the present disclosure. It needs to be stated that the following embodiments and the features in the embodiments can be combined with one another if no conflict will result.

It needs to be stated that the drawings provided in the following embodiments are just used for schematically describing the basic concept of the present disclosure, thus only illustrating components only related to the present disclosure and are not necessarily drawn according to the numbers, shapes and sizes of components during actual implementation, the configuration, number and scale of each component during actual implementation thereof may be freely changed, and the component layout configuration thereof may be more complicated. Furthermore, unless otherwise indicated herein, the use of relational terms, if any, such as first and second and the like are used solely to distinguish one entity or action from another entity or action without necessarily requiring or implying any actual such relationship or order between such entities or actions.

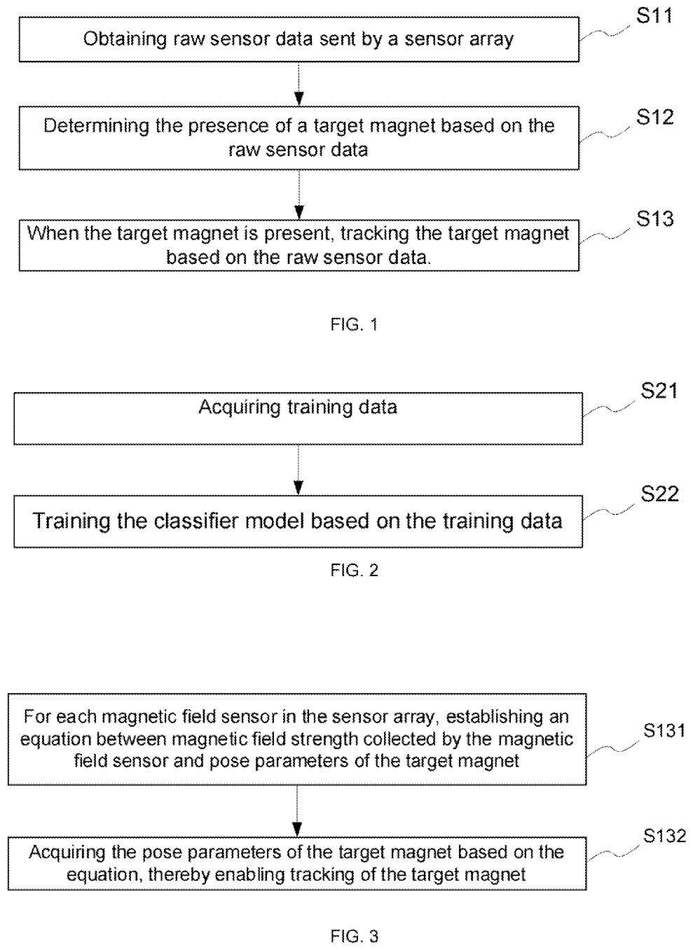

In one embodiment of the present disclosure, a permanent-magnet-based object tracking method is provided, which is applied to a backend of an object tracking device. Specifically, referring to FIG. 1, the object tracking method includes:

S11, obtaining raw sensor data sent by a sensor array, the sensor array including a plurality of magnetic field sensors, the raw sensor data including magnetic field strengths at the locations of the magnetic field sensors.

S12, determining if a target magnet is present based on the raw sensor data, where the target magnet is a permanent magnet provided on a target object, and the target object includes, but is not limited to, a hand of a user. In particular, when the target object is a hand of a user, the target magnet may be worn on the user's finger.

S13, when the target magnet is present, tracking the target magnet based on the raw sensor data.

As can be seen from the above, the present disclosure provides a permanent-magnet-based object tracking method. When the target object is a hand of a user, the object tracking method enables accurate hand tracking based on a magnetic field, which is line-of-sight independent and does not infringe on the user's privacy. And, because permanent magnets require no maintenance, they can be worn on the hand all the time, with only the sensor plate needing to be charged, just like a smartwatch. In addition, as the permanent-magnet-based object tracking method does not depend on the IMU unit for implementation, there are no drifting problems.

Further, since the magnetic field strength decays regularly with respect to distance, the magnetic field strength generated by a magnet placed in the far field is too weak to be sensed by magnetic field sensors. Therefore, tracking of the far-field magnet can be both power-consuming and inaccurate. To address this problem, the present disclosure detects the near-field presence of the target magnet in operation S12, and tracks the target magnet only when the target magnet is present in the near-field in operation S13, which helps to reduce power consumption and improve the accuracy of tracking. Hereinafter, the target magnet is “present” when it is present in the near-field.

Optionally, the object tracking method further includes: controlling the backend to enter a sleep mode when the target magnet is not present, as a way to provide smooth and efficient tracking performance, while further saving power.

In an embodiment of the present disclosure, the determining of the presence of a target magnet based on the raw sensor data includes: classifying, using a trained classifier model, the raw sensor data, to determine the presence of the target magnet, where the classifier model may be, for example, a support vector machine (SVM) classifier whose kernel function may be radial basis function (RBF) and the like.

Optionally, referring to FIG. 2, a method for raining the classifier model includes:

S21, acquiring training data, where the training data includes sensor data and labels corresponding to the sensor data, the labels being, for example, the absence of magnets within the sensing range, or the presence of one or more magnets within the sensing range.

Optionally, the training data may be acquired using an emulation-driven method. Specifically, the corresponding sensor data is generated by simulation under the condition that two magnets are placed at random positions and orientations. During simulation, the magnetic moment and the strength of the earth's magnetic field are constant. Based on the above, the training data can be obtained by labeling the sensor data generated by the simulation. For example, the sensor data may be labeled into the following two categories: absence of magnets within the sensing range, and presence of one or two magnets within the sensing range.

Furthermore, during the simulation, the sensing range may be chosen according to the tracking performance; for example, the sensing range may be determined as the maximum distance from the sensor where the tracking error is within 2 cm.

S22, training the classifier model based on the training data, where the method for training the classifier model may be implemented using existing algorithms, which will not be described herein in detail.

According to the above description, the present disclosure provides a method for determining the presence of a target magnet, which includes generating training data by means of data simulation to realize the training of the classifier model, and classifying the raw sensor data based on the trained classifier model to obtain a judgment result. However, the present disclosure is not limited to the above, and other methods can be used in practical applications to determine the presence or absence of the target magnet.

Referring to FIG. 3, in an embodiment of the present disclosure, a method for tracking a target magnet includes:

S131, for each magnetic field sensor in the sensor array, establishing an equation between magnetic field strength collected by the magnetic field sensor and pose parameters of the target magnet, where the pose parameters reflect the position and the motion attitude of the target magnet. Since the position, as well as the motion attitude of the target magnet, affects its magnetic field distribution, in operation S131, an equation can be established between the magnetic field strength collected by each of the magnetic field sensors and the pose parameters of the target magnet.

S132, acquiring the pose parameters of the target magnet based on the equation, thereby enabling tracking of the target magnet. Specifically, each magnetic field sensor corresponds to an equation, and a system of equations can be obtained by combining the equations corresponding to the plurality of magnetic field sensors. The pose parameters of the target magnet can be obtained by solving the system of equations.

Optionally, the pose parameters include a magnetic moment vector of the target magnet and a position vector pointing from the target magnet to the sensor array. The equation is expressed as:

$$\vec{{B}_{i}} = \vec{G} + {\sum }_{j = 1}^{n} \frac{{μ}_{0}}{4 π} ⨯ ( \frac{3 ⨯ ( {\vec{m}}_{j} ⨯ {\vec{r}}_{ij} )}{{\vert {\vec{r}}_{ij} \vert}^{5}} - \frac{{\vec{m}}_{j}}{{\vert {\vec{r}}_{ij} \vert}^{3}} ) ,$$

where [symbol] is the magnetic field strength collected by the [symbol] -th magnetic field sensor in the sensor array, [symbol] is the number of the target magnets, [symbol] is the environmental magnetic field strength, [symbol] is the vacuum permeability, [symbol] is the magnetic moment vector of the [symbol] -th target magnet, and [symbol] is the position vector pointing from the [symbol] -th target magnet to the [symbol] -th magnetic field sensor.

Optionally, since the magnitude of the magnetic moment is a constant, the magnetic moment vector for the [symbol] -th target magnet may be described in a spherical coordinate system as:

$${\vec{m}}_{j} = {m}_{j} ⨯ ( \begin{matrix}sin θ cos ϕ \\ sin θ sin ϕ \\ cos θ\end{matrix} ) ,$$

where [symbol] is the magnitude of the magnetic moment of the [symbol] -th target magnet, [symbol] and [symbol] are two parameters in the spherical coordinate, respectively.

Based on the above equations, it is clear that 3+6×n parameters are required in total to track n target magnets. That is, information on 3+6×n degrees of freedom is required. Also, since each magnetic field sensor is able to establish equations on three different axes, i.e., each magnetic field sensor can provide information on three degrees of freedom, the number of magnetic field sensors should be greater than or equal to (3+6×n)/3. For example, for the tracking of two target magnets, information on fifteen degrees of freedom needs to be identified. As each magnetic field sensor can provide information on three degrees of freedom, theoretically, five magnetic field sensors are needed to achieve the tracking of two target magnets. Preferably, in order to limit power consumption while making the system more robust and accurate, eight magnetic field sensors may be selected to achieve the tracking of two target magnets.

Optionally, in operation S132, the equations corresponding to the plurality of magnetic field sensors may be combined into a system of equations, and the pose parameters of the target magnet can be obtained by solving the system of equations. Since the system of equations is a combination of multiple nonlinear equations, the obtaining of its analytical solution in practical applications can be difficult. For this problem, preferably, the Levenberg-Marquardt (LM) algorithm is used to solve the system of equations, to obtain the pose parameters of the target magnet.

Optionally, to reduce the impact of environmental noise on tracking performance, the object tracking method of the present disclosure further includes: applying sliding window filtering to the raw sensor data to suppress abnormal high-frequency noise; adding a Kalman filter on the output of the LM algorithm to filter the output of the LM algorithm, for smoothing the tracking path and providing a feasible guess for the initialization of the next data point.

As can be seen from the above description, the present disclosure provides a method for tracking a target magnet, in which the magnetic field strength collected by each of the magnetic field sensors can be represented as a linear combination of the magnetic field strength generated by each of the target magnets and the environmental magnetic field strength. This method fully considers the impact of the environmental magnetic field on the total magnetic field strength, thus obtaining pose parameters with higher accuracy and enabling accurate magnet tracking.

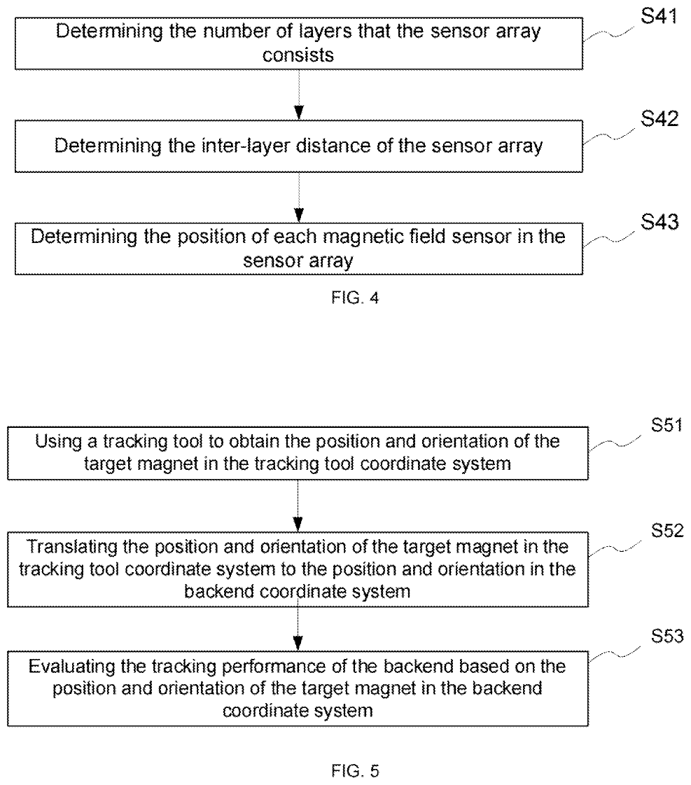

Referring to FIG. 4, in an embodiment of the present disclosure, a method for designing the sensor array includes:

S41, determining the number of layers that the sensor array consists. Preferably, the sensor array has two layers; the magnetic field sensors are dispersed on different layers to maximize the distance between individual magnetic field sensors while minimizing the impact of the sensor array on any plane, i.e., this design can make the sensor array smaller without reducing the distances between the sensors. As to why more layers are not adopted, it is because: on the one hand, it would be technically easier and cheaper to produce a PCB board with two layers compared to those with three or more layers; on the other hand, a multi-layer PCB usually uses pin headers to communicate between layers, and the number of pin headers increases with more layers, and using too many pin headers may introduce noise to data transmission. Therefore, the two-layer (instead of three or more) layout helps to reduce the number of pin headers and thus reduce the noise during data transmission.

S42, determining the inter-layer distance of the sensor array. Specifically, operation S42 can determine the inter-layer distance of the sensor array based on both the diversity of data collected by the sensor array and the volume of the device. On the one hand, the larger the distance between layers, the more diverse the spatial information gathered by the magnetic field sensor array. On the other hand, the larger the distance between layers, the larger the device will be, which might make the device too bulky to wear. Furthermore, the size of pin headers connecting the upper and lower layer should meet the specifications.

S43, determining the position of each magnetic field sensor in the sensor array.

Preferably, when the number of magnetic field sensors is eight and the sensor array has a two-layer layout. Four sensors are placed on the vertices of an upper square of the array, and another four sensors are placed on the vertices of a lower square of the array. The upper layer square and the lower layer square are staggered in such a way that a diagonal of the upper square and a diagonal of the lower square are at an angle of 45°. Not only does this design maximize the distance between different sensors, but the design can also minimize potential shielding issues caused by large copper PCB boards by hollowing out unused parts of the PCB boards.

Optionally, the object tracking method further includes: obtaining an optimal layout among all sensor layouts designed based on the same constraints, and comparing the layouts described in S41 to S43 with the optimal layout. The way to obtain the optimal layout includes the operations of simulation design, particle swarm optimization (PSO) algorithm and objective function determination, which will be described in detail next.

In the operation of simulation design, the premise of finding an optimal layout with the aid of a computer is simulating the magnetic field of a magnet and the corresponding measurement. In the simulation process, the present disclosure uses a magnetic dipole model and assumes there is no interference between two magnets. Therefore, the magnetic field strength collected by the magnetic field sensors can be depicted as the linear combination of the magnet field strength.

The present disclosure provides a three-step simulation process: simulating the ideal sensor readings, adding sensor noise, and quantifying sensor readings. First, theoretical magnetic field sensor readings (i.e., without noises) are calculated based on the given magnet parameters: magnet position, magnetic moment orientation, magnitude of the magnetic moment, and the sensor layout. The theoretical magnetic field sensor readings may be calculated by corresponding equations, the corresponding equations being expressed as, for example:

$$\vec{B} = \frac{{μ}_{0}}{4 π} ⨯ ( \frac{3 ⨯ ( \vec{m} ⨯ \vec{r} )}{{\vert \vec{r} \vert}^{5}} - \frac{\vec{m}}{{\vert \vec{r} \vert}^{3}} ) and \vec{m} = m ⨯ ( \begin{matrix}sin θ cos ϕ \\ sin θ sin ϕ \\ cos θ\end{matrix} ) ,$$

where [symbol] is the magnetic field strength, [symbol] is the magnetic moment vector, [symbol] is the vector pointing from the target magnet to the observation point, and m is the magnitude of the magnetic moment vector. The environmental magnetic field strength is set by looking up the local earth magnetic field strength. The second operation is to add Gaussian noise to the equation calculation results according to the data sheet of the magnetic field sensors. Finally, the sensor reading is quantified according to the sensor resolution. The simulation result is time-series magnetic field sensor reading corresponding to the magnet's moving trajectory. In practice, NumPy may be used to implement the above simulation process.

In the operation of the PSO algorithm, the simulation data is used to evaluate the performance of the sensor array. The goal of the present disclosure is to find the hardware layout with the best tracking performance. However, finding the optimal layout is an NP-hard problem as the placement combinations of magnetic sensors are uncountable. The gradient-based optimization would also fall short as LM algorithm is indifferentiable. Therefore, the present disclosure uses the PSO algorithm to solve this problem. Specifically, first, multiple (for example, 500) possible layouts (given 8 sensors placed on two parallel planes) are randomly initialized, each layout is denoted as a particle in the PSO algorithm. Each particle is a 24-dimensional array for representing the 3D positions of 8 magnetic field sensors. The goal of the present disclosure is to find the overall optimal layout from the above multiple layouts.

In each iteration, every particle updates its position and velocity by using a PSO update rule. The PSO update rule may be, for example,

$$\{ \begin{matrix}\text{?} = ω ⨯ \text{?} + {c}_{1} ⨯ {r}_{1} ⨯ ( \text{?} ) + {c}_{2} ⨯ {r}_{2} ⨯ ( \text{?} ) \\ \text{?} = \text{?}\end{matrix} ,$$

$$\text{?} \text{indicates text missing or illegible when filed}$$

where [symbol] and [symbol] denotes the velocities of particle [symbol] at moment [symbol] and moment [symbol] , respectively; [symbol] denotes the position of particle [symbol] at moment [symbol] ; [symbol] denotes the optimal position of particle [symbol] as of moment [symbol] ; [symbol] denotes the optimal position found among all particles as of moment [symbol] ; [symbol] denotes the position of particle [symbol] at moment [symbol] ; [symbol] , [symbol] , and [symbol] are hyper-parameters; [symbol] and [symbol] are random numbers drawn from a uniform distribution between 0 and 1. The objective function is the tracking performance function of one moving magnet within a usage-dependent range. For example, in a face touching detection application, the distance between the sensor array and the boundary of the user's face is within 30 cm. Then, within the sensing range, the present disclosure uniformly samples data points to evaluate the layout's tracking performance. After each iteration, each particle updates its optimal layout and the corresponding objective function value. The global optimization results are also updated. Finally, the algorithm stops after a preset number (e.g., 1000) of iterations, and the resulting global best layout is used as the final optimal layout.

In addition, since the n sensors are interchangeable, the optimal solution may have different expressions and can be misleading. As a result, at each iteration, the present disclosure sorts the sensors based on their coordinates to avoid the duality of the optimal solution.

In the operation of determining the objective function, the most intuitive idea to evaluate the performance of the sensor array is to compare the average tracking performance of the LM algorithm with that of a pre-defined route. However, this method has two drawbacks: (1) the tracking error will be affected by the random noises; (2) the moving route may not reveal the overall tracking performance of the sensor array. To overcome these drawbacks, the present disclosure uses an objective function based on unscented transformation. The unscented transformation is used to evaluate the effect of applying a nonlinear transformation to a probability distribution. The key idea is to select some points, denoted as the Σ points, in the original distribution, pass these points to the nonlinear function and evaluate the mean and variance of the resulting distribution. The constraints for choosing the Σ points are listed in the equation below:

$$1 = {\sum }_{i} {ω}_{i}^{m} , 1 = {\sum }_{i} {ω}_{i}^{c} , μ = {\sum }_{i} {ω}_{i}^{m} \times f ( {x}_{i} )$$

$$\sum = \text{?} \times ( f ( {x}_{i} ) - μ ) \times {( f ( {x}_{i} ) - μ )}^{T}$$

$$\text{?} \text{indicates text missing or illegible when filed}$$

for the [symbol] -th particle, [symbol] and [symbol] are the hyper-parameters of the mean and variance, respectively; ƒ(xᵢ) is the corresponding probability density function. Each point Σ converts to value γ through the nonlinear transformation. The mean value μ and the variance of the resulting distribution can be calculated using the following equations:

$$μ = {\sum }_{i = 0}^{2 n} {ω}_{i}^{m} \times {γ}_{i} , variance = {\sum }_{i = 0}^{2 n} {ω}_{i}^{c} \times ( {γ}_{i} - μ ) \times {( {γ}_{i} - μ )}^{T}$$

Since the LM algorithm is a non-linear function that maps the sensor reading to the magnet position, the present disclosure uses unscented transformation to calculate the uncertainty of the tracking result. The sensor reading is modeled as a normal distribution with ideal sensor reading as mean and measurement noise as variance. By applying the unscented transformation to the sensor reading distribution, the mean value and variance of the magnet position can be calculated. In addition, using the norm of the eigenvalues of the magnet position co-variance matrix, the uncertainty of the tracking result can be measured in a deterministic way.

Based on the above operations, an optimal layout solution of the sensor array can be obtained, and the performance of the layout method described in the operations S41 to S43 can be evaluated based on the tracking performance of the optimal layout solution at different distances. Through practical tests, it can be seen that the layout solution determined by the operations S41˜S43 has comparable tracking performance with the optimal layout solution at different distances, and its cost is lower.

In practical applications, the reading of magnetic field sensors can be easily polluted by hard-/soft-iron effect. Thus, in an embodiment of the present disclosure, the object tracking method further includes: calibrating the sensor array in an environment far away from any magnetic substance, so that each of the magnetic field sensors in the sensor array collects uniform magnetic field strength when rotated to different directions.

Specifically, in an environment far away from any magnetic substance, collecting magnetic field sensor readings while randomly rotating the sensor array. The collected magnetic field sensor readings may have a different bias and scale. These errors can be removed using the standard calibration algorithm. When the measured readings of all magnetic field sensors in the sensor array are uniform in all directions, the calibration of the magnetic field sensors is complete, and the target magnets are ready for the tracking. Furthermore, since the intrinsic hard and soft-iron effects of the sensor array are stable during operation, only one calibration is required before conducting a series of experiments/usages.

Referring to FIG. 5, in an embodiment of the present disclosure, the object tracking method further includes:

S51, using a tracking tool to obtain the position and orientation of the target magnet in the tracking tool coordinate system.

Preferably, the tracking tool is a pen-shaped tool, which includes: a cylindrical stick with a semi-spherical slot on top, a spherical neodymium magnet, and a cap with a tip. The magnet is embedded at the top of the stick and enclosed by the cap, with its north pole pointing towards the tip. The magnetic field flux distribution of the spherical neodymium magnet is close to that of a magnetic dipole.

S52, translating the position and orientation of the target magnet in the tracking tool coordinate system to the position and orientation in the backend coordinate system. The tracking tool coordinate system is a coordinate system established with a point on the tracking tool as the original point, and the backend coordinate system is a coordinate system established with a point on the backend as the original point.

S53, evaluating the tracking performance of the backend based on the position and orientation of the target magnet in the backend coordinate system.

It is to be noted that the application scenario of the object tracking method of the present disclosure is not limited to hand recognition. For example, the object tracking method may be applied to scenarios such as face touching detection, controller-free AR interaction, and endocapsule tracking. The categories of the target objects and the application scenarios of the tracking methods are not limited herein.

Based on the above description of the object tracking method, the present disclosure further provides a non-transitory computer-readable storage medium, which stores a computer program, the computer program implementing the object tracking method shown in FIG. 1 when executed by a processor.

Based on the above description of the object tracking method, the present disclosure further provides a backend of an object tracking device, the backend including: a sensor array for obtaining magnetic field data at the location of the sensor array as raw sensor data, the sensor array including a plurality of magnetic field sensors; a processor, communicatively connected to the sensor array, for determining the presence of a target magnet based on the raw sensor data, and when the target magnet is present, tracking the target magnet based on the raw sensor data; the target magnet is a permanent magnet provided on a target object. Specifically, said processor may use the object tracking method shown in FIG. 1 to realize the tracking of the target magnet, which will not be described herein in detail for saving space in the specification.

Based on the above description of the object tracking method, the present disclosure further provides a permanent-magnet-based object tracking device. The object tracking device includes: at least one target magnet to be provided on a target object, the target magnet being a permanent magnet; a backend, including a sensor array and a processor, where the sensor array is used to obtain magnetic field data at the location of the sensor array as raw sensor data, and the processor is communicatively connected to the sensor array, for determining if the target magnet is present based on the raw sensor data, and tracking, when the target magnet is present, the target magnet based on the raw sensor data. Specifically, said processor may use the object tracking method shown in FIG. 1 to realize the tracking of the target magnet, which will not be described herein in detail for saving space in the specification.

Optionally, when the object tracking device is used for hand tracking, the backend may be set on the user's body in the form of a hat or a badge. When the backend is a cap, the user will be wearing a cap with the sensor array placed on the brim and wearing two target magnets on each index finger. Since the target magnets are directly attached to the fingers, their positions can serve as good approximations of fingertip positions. When the backend is a badge, the sensor array and magnets should be placed at the user's chest and wrists, respectively. To find the fingertip positions, the north pole of the magnet is pointing towards a natural extending direction of relaxed fingertips. In this way, the positions of index fingertips can be approximated with the magnets' positions and orientations together with the length of a relaxed hand.

The protection scope of the permanent-magnet-based hand tracking method as described in the present disclosure is not limited to the sequence of operations listed herein. Any scheme realized by adding or subtracting operations or replacing operations of the traditional techniques according to the principle of the present disclosure is included in the protection scope of the present disclosure.

The present disclosure further provides a permanent-magnet-based hand tracking device, which can implement the permanent-magnet-based hand tracking method described in the present disclosure. However, the realizing device of the permanent-magnet-based hand tracking method as described in the present disclosure is not limited to the structure of the permanent-magnet-based hand tracking device as listed herein. Any structural deformation and replacement of existing techniques made according to the principle of the present disclosure are included in the protection scope of the present disclosure.

In summary, the permanent-magnet-based object tracking method described in the present disclosure can realize the tracking of target objects. When the target object is a hand of a user, the permanent-magnet-based object tracking method enables accurate hand tracking based on a magnetic field, which is line-of-sight independent and does not infringe on the user's privacy. Further, since permanent magnets require no maintenance, they can be worn on the hand all the time, with only the sensor plate needing to be charged, just like a smartwatch. In addition, as the permanent-magnet-based object tracking method does not depend on the IMU unit for implementation, there are no drifting problems. Therefore, the present disclosure effectively overcomes various shortcomings in the existing technology and has high industrial utilization value.

The above-mentioned embodiments are merely illustrative of the principle and effects of the present disclosure instead of limiting the present disclosure. Modifications or variations of the above-described embodiments may be made by those skilled in the art without departing from the spirit and scope of the disclosure. Therefore, all equivalent modifications or changes made by those who have common knowledge in the art without departing from the spirit and technical concept disclosed by the present disclosure shall be still covered by the claims of the present disclosure.

What is claimed is:

1. A permanent-magnet-based object tracking method, which is applied to a backend of a tracking device, wherein the method comprises:
obtaining raw sensor data sent by a sensor array, wherein the sensor array comprises a plurality of magnetic field sensors, and the raw sensor data comprises magnetic field strengths at locations of the magnetic field sensor;
determining a presence of a target magnet based on the raw sensor data, wherein the target magnet is a permanent magnet provided on a target object; and
tracking, when the target magnet is present, the target magnet based on the raw sensor data.

2. The method according to claim 1, wherein the determining of the presence of the target magnet based on the raw sensor data comprises:
classifying, using a trained classifier model, the raw sensor data, to determine the presence of the target magnet.

3. The method according to claim 1, wherein a method for implementing the tracking of the target magnet comprises:
for each of the plurality of magnetic field sensors in the sensor array, establishing an equation between the magnetic field strength collected by the magnetic field sensor and pose parameters of the target magnet; and
acquiring the pose parameters of the target magnet based on the equation, thereby enabling tracking of the target magnet.

4. The method according to claim 3, wherein the pose parameters comprises a magnetic moment vector of the target magnet and a position vector pointing from the target magnet to the sensor array; the equation is expressed as:
$$\vec{{B}_{i}} = \vec{G} + {\sum }_{j = 1}^{n} \frac{{μ}_{0}}{4 π} ⨯ ( \frac{3 ⨯ ( {\vec{m}}_{j} ⨯ {\vec{r}}_{ij} )}{{\vert {\vec{r}}_{ij} \vert}^{5}} - \frac{{\vec{m}}_{j}}{{\vert {\vec{r}}_{ij} \vert}^{3}} ) ,$$
wherein [symbol] is the magnetic field strength collected by the [symbol] -th magnetic field sensor in the sensor array, [symbol] is the number of the target magnets, [symbol] is the environmental magnetic field strength, [symbol] is the vacuum permeability, [symbol] is a magnetic moment vector of the [symbol] -th target magnet, and [symbol] is a position vector pointing from the [symbol] -th target magnet to the [symbol] -th magnetic field sensor.

5. The method according to claim 1, wherein a method for designing the sensor array comprises:
determining the number of layers that the sensor array consists;
determining an inter-layer distance of the sensor array; and
determining a position of each magnetic field sensor in the sensor array.

6. The method according to claim 1, further comprising: calibrating the sensor array, so that each of the plurality of magnetic field sensors in the sensor array collects uniform magnetic field strength when rotated to different directions.

7. The method according to claim 1, further comprising:
using a tracking tool to obtain a position and orientation of the target magnet in a tracking tool coordinate system;
translating the position and orientation of the target magnet in the tracking tool coordinate system to a position and orientation in a backend coordinate system; and
evaluating the tracking performance of the backend based on the position and orientation of the target magnet in the backend coordinate system.

8. A backend of an object tracking device, comprising:
a sensor array, for obtaining magnetic field data at a location of the sensor array as raw sensor data, wherein the sensor array comprises a plurality of magnetic field sensors; and
a processor, communicatively connected to the sensor array, for determining if a target magnet is present based on the raw sensor data, and tracking, when the target magnet is present, the target magnet based on the raw sensor data; wherein the target magnet is a permanent magnet provided on a target object.

9. A permanent-magnet-based object tracking device, comprising:
at least one target magnet, to be provided on a target object, wherein the target magnet is a permanent magnet;
a backend, comprising a sensor array and a processor, wherein
the sensor array is used for obtaining magnetic field data at a location of the sensor array as raw sensor data; and
the processor is communicatively connected to the sensor array, for determining if the target magnet is present based on the raw sensor data, and tracking, when the target magnet is present, the target magnet based on the raw sensor data.

10. A computer readable storage medium, which stores a computer program, wherein the computer program implements, when executed by a processor, the permanent-magnet-based object tracking method according to claim 1.
